(19) United States
(12) Patent Application Publication
(10) Pub. No.: US 2016/0313488 A1
(43) Pub. Date: Oct. 27, 2016

(54) DISPLAY DEVICE

(71) Applicant: InnoLux Corporation, Miao-Li County (TW)

(72) Inventors: Chi-Liang CHANG, Miao-Li County (TW); Tai-Chi PAN, Miao-Li County (TW)

(21) Appl. No.: 15/088,223

(22) Filed: Apr. 1, 2016

(30) Foreign Application Priority Data
Apr. 27, 2015 (CN) 201510202226.4

(51) Int. Cl. F21V 8/00

(52) U.S. Cl. CPC G02B 6/0016; G02B 6/0078; G02B 6/002; G02B 6/0068; G02B 6/0088

(57) ABSTRACT

A display device is disclosed, which comprises: a display panel; a light guide plate disposed on a side of the display panel and having a light-incident surface and a thickness; and a light-emitting unit disposed adjacent to the light-incident surface of the light guide plate, wherein at least one rough region is formed on the light-incident surface, and a surface of the rough region has roughness in a range from 0.18 μm to 0.7 mm.

### CROSS REFERENCE TO RELATED APPLICATION

This application claims the benefits of the Chinese patent application Serial Number 201510202226.4, filed on Apr. 27, 2015, the subject matter of which is incorporated herein by reference.

### BACKGROUND

1. Field

The present invention relates to a display device, and more particularly, to a display device comprising a light guide plate having improved light entry efficiency. Furthermore, the present invention provides a method for manufacturing the light guide plate.

2. Description of Related Art

As the development of electronic products progresses, liquid crystal display devices have become widely used in a variety of electronic products such as smart phones, tablet PCs, notebooks, computers, televisions, or car dashboards in recent years. In addition to the performance of these devices, the display quality of these devices is also highly demanded by users. The display quality may be affected by many factors and one of which may be the backlight module of display device. Thus, backlight module has been extensively studied.

In backlight module, a light guide plate is critical for light guiding, which transmits the light from a light source toward the distal end of the light guide plate based on the total internal reflection principle. The light is reflected and diffused to various directions by utilizing a printed pattern on the bottom surface of the light guide plate. The printed pattern may be designed to have diffusion dot patterns in various sizes and in various densities. These dot patterns can destruct the total reflection of light and guide the light toward the front of the light guide plate. Hence, the luminance of the panel is improved and the uniformity of the luminance is controlled.

Currently, the raw materials for manufacturing light guide plates are mainly polymethyl methacrylate (PMMA) resin and polycarbonate (PC). The conventional methods for manufacturing light guide plates include forming a motherboard first through a hot pressing method or an injection method. The motherboard is then cut into a plurality of light guide plates in appropriate sizes by cutting tools or laser. The edges of the light guide plates are then polished to obtain the final light guide plates. These light guide plates can then be applied to a backlight module of a display device.

However, the conventional methods for manufacturing light guide plates may be time-consuming and expensive due to the required cutting process to obtain light guide plates in appropriate sizes. Thereby, there is a need to provide a method to manufacture light guide plates in a simpler and more economical way. Moreover, it is desirable to obtain light guide plates with improved light entry efficiency without deteriorating the light guiding effect.

### SUMMARY

According to some embodiments, an object is to provide a display device comprising a light guide plate with improved light entry efficiency where the luminance and the uniformity of the luminance of the panel and the subsequent display quality of the display device may be enhanced.

According to some embodiments, another object is to provide a display device comprising a bendable light guide plate. The light guide plate in a combination with a light source or the display device can be used as a curved display in cell phone, TV, or car dashboard.

According to some embodiments, another object is to provide a method for manufacturing a light guide plate, which omits a conventional cutting process. Accordingly, the light guide plate can be manufactured though a simple and economical way. The obtained light guide plate can have improved light entry efficiency and enhanced light guiding effect.

To achieve the object, a display device is provided, which comprises a display panel; a light guide plate disposed on a side of the display panel and having a light-incident surface and a thickness; and a light-emitting unit disposed adjacent to the light-incident surface of the light guide plate; wherein at least one rough region is formed on the light-incident surface, and a surface of the rough region has roughness in a range from 0.18 μm to 0.7 mm.

For the light guide plates used in conventional display devices, when a light emitting unit emits a light toward the light guide plate, part of the light may be reflected from the light-incident surface of the light guide plate, decreasing the amount of light entering the light guide plate. However, for the light guide plate of some embodiments of the present invention, since there is at least one rough region formed on the light-incident surface, when a light emitting unit emits a light toward the light guide plate, most of the light can be refracted into the light guide plate, increasing the amount of light entering the light guide plate, thus improving light entry efficiency.

The rough region may be a protrusion having a rough surface. More specifically, the rough surface is formed on a side of the protrusion that is not in contact with the light guide plate. The thickness of the protrusion is thinner than that of the light guide plate. The rough surface, for example, may have a structure with an irregular uneven surface or a structure formed by a polyhedron with staggered arrangement in various depths, but is not limited thereto. In addition, the rough surface may have a roughness in a range from 0.18 μm to 0.7 mm, and for example, from 0.4 μm to 0.5 mm.

Another embodiment of the present invention provides a display device, comprising a display panel, a light guide plate, and a light-emitting unit. The light guide plate is disposed on a side of the display panel and has a light-incident surface. The light guide plate includes a plurality of light guide units. The light-emitting unit is disposed adjacent to the light-incident surface of the light guide plate. At least two adjacent light guide units are linked by at least one linking unit. In this embodiment, since the light guide plate comprises a plurality of light guide units linked to each other by linking units, the light guide plate can be a bendable light guide plate, which can be applied in a curved display.

In the above-mentioned display device, at least one rough region can be formed on the light-incident surface of the light guide plate. Thus, the light entry efficiency can be increased. The structure and the roughness of the rough region may be the same as defined above and will not be described here again.

The present invention also provides a method for manufacturing a light guide plate through a simple and economical way, which may comprise the steps of: (a) forming a motherboard, which comprises a plurality of light guide units linked together by at least one linking unit; and (b) disconnecting at least two adjacent light guide units along the linking unit.

Other objects, advantages, and novel features of the invention will become more apparent from the following detailed description when taken in conjunction with the accompanying drawings.

### BRIEF DESCRIPTION OF THE DRAWINGS

FIG. 1A to 1C are schematic diagrams of an exemplary embodiment showing the manufacturing method of a light guide plate;

FIG. 2A to 2C are schematic diagrams of an exemplary embodiment showing a light guide plate;

FIGS. 3A and 3B are schematic diagrams after disconnecting the light guide units of FIG. 2A along the linking units;

FIG. 3C is a schematic diagram showing the configuration of the light source of the light-emitting unit with respect to the rough region after disconnecting the light guide units;

FIG. 3D is another schematic diagram showing the configuration of the light source of the light-emitting unit with respect to the rough region after disconnecting the light guide units;

FIGS. 3E and 3F are other schematic diagrams showing the configuration of the light source of the light-emitting unit with respect to the rough region of the light guide plate;

FIGS. 4A and 4B are schematic diagrams of an exemplary embodiment showing a structure of the linking unit;

FIGS. 4C and 4D are schematic diagrams of an exemplary embodiment showing a structure of the linking unit;

FIGS. 4E and 4F are schematic diagrams of an exemplary embodiment showing a structure of the linking unit;

FIGS. 5A and 5B are schematic diagrams of an exemplary embodiment showing a structure of the linking unit;

FIGS. 5C and 5D are schematic diagrams of an exemplary embodiment showing a structure of the linking unit;

FIGS. 5E and 5F are schematic diagrams of an exemplary embodiment showing a structure of the linking unit;

FIGS. 5G and 5H are schematic diagrams of an exemplary embodiment showing a structure of the linking unit;

FIG. 6A to 6C are schematic diagrams of an exemplary embodiment showing a structure of the linking unit;

FIG. 7A to 7C are schematic diagrams of an exemplary embodiment showing a structure of the linking unit;

FIG. 8A to 8C are schematic diagrams of an exemplary embodiment showing a structure of the linking unit;

FIG. 9A to 9C are schematic diagrams of an exemplary embodiment showing a structure of the linking unit;

FIGS. 10A and 10B are schematic diagrams of an exemplary embodiment showing a bendable light guide plate;

FIGS. 11A and 11B are schematic diagrams of an exemplary embodiment showing a bendable light guide plate;

FIG. 12 is a schematic diagram of an exemplary embodiment showing a bendable light guide plate;

FIG. 13 is a schematic diagram of an exemplary embodiment showing a display device.

### DETAILED DESCRIPTION OF THE PREFERRED EMBODIMENT

In the following disclosure, the afore-said features will be described in detail. However, the following examples are merely intended to illustrate embodiments of the present invention so that a person having ordinary skills in the art may understand the advantages and the effects of the present invention. The present invention may also be applied and implemented in various embodiments. The details in the disclosure may also have various modifications or changes depending on the application without departing from the spirit of the present invention.

### EXAMPLE 1

### Method for Manufacturing a Light Guide Plate

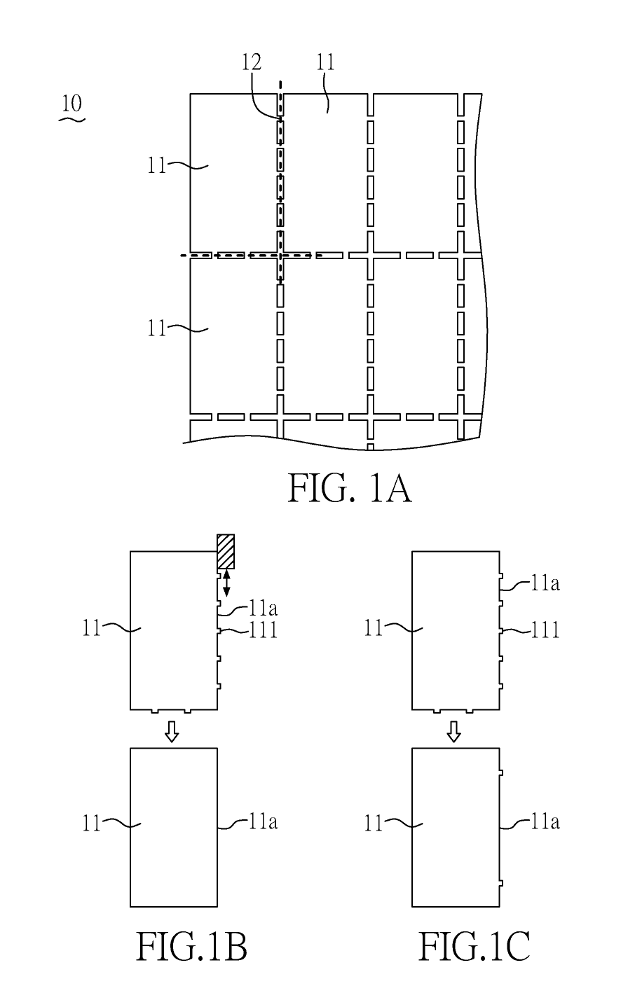

Please refer to FIG. 1, a motherboard 10 is formed by a hot pressing method or an injection method. The motherboard 10 comprises a plurality of light guide units 11. At least one linking unit 12 is disposed between adjacent light guide units 11 to link them together. Adjacent light guide units 11 may be disconnected by bending and breaking the linking units 12. After breaking, the linking units 12 can remain on the edges of the light guide units 11 to form protrusions 111. The protrusions 111 may be removed by polishing the edges of the light guide units 11 (FIG. 1B). By partly polishing, part of the protrusions 111 may be retained (FIG. 1C). Or, without polishing, all of the protrusions 111 can be remained (not shown). In this case, the protrusions 111 surrounding the light guide units 11 may be used for positioning Specifically, the protrusions 111 can correspond to the grooves on the border of a display device (not shown) so that the light guide unit 11 and the display device can be assembled together quickly. Each individual disconnected light guide unit 11 may be used as a light guide plate or a plurality of light guide units 11 linked by linking units 12 may be used as a light guide plate. Microstructures, such as dots, may be formed on the upper and/or the bottom surfaces of the light guide plate. According to some embodiments, due to the novel design of the present invention, the cutting process in the manufacturing of a light guide plate can be omitted. Consequently, the cost of buying cutting equipment can be eliminated. Moreover, according to some embodiments, polishing part of the edges of the light guide plate is enough without the necessity to polish the entire edges of the light guide plate.

In the following disclosure, the structures of the linking units 12 between the light guide units 11 will be described via several embodiments. The effect of the disconnected light guide units 11 as the light guide plates when used in a display device will also be explained in detail as well. However, the structures of the linking units 12 described and shown in the following are for illustration only, but not limiting the scope of the present invention.

### EXAMPLE 2

### Linking Unit and Light Guide Plate

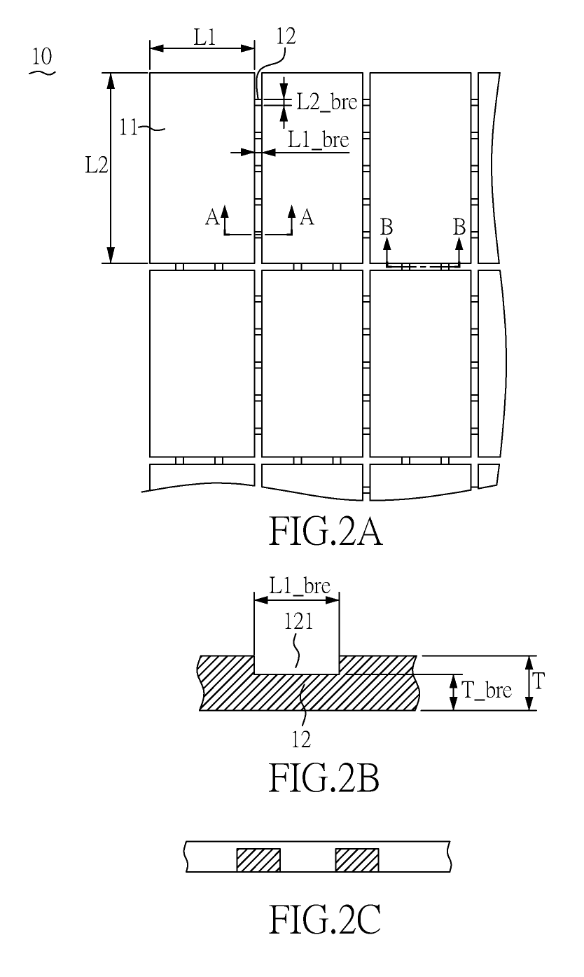

FIG. 2A shows a motherboard 10 comprising a plurality of light guide units 11 (as shown in FIG. 1A). Adjacent light guide units 11 are linked together by at least one linking unit 12. FIG. 2B is a cross-sectional view taken along line A-A in FIG. 2A, and FIG. 2C is a cross-sectional view taken along line B-B in FIG. 2A. In FIG. 2A, L1 represents a width of a light guide unit 11; L2 represents a length of a light guide unit 11; L1_bre represents a length of a linking unit 12; and L2_bre represents a width of a linking unit 12. In the embodiment, relationships of L1>L1_bre and L2>L2_bre are satisfied. As FIGS. 2A and 2B show, a thickness of the linking unit 12 (T_bre) is thinner than a thickness of the motherboard 10 (T). When adjacent light guide units 11 are disconnected along the linking units 12, disconnections happen on the linking units 12. The thickness of the motherboard (T) may be adjusted according to the device the motherboard will be applied to, which may be in a range from 0.1 mm to 3 mm, such as 3 mm, 1 mm, 0.55 mm, or even 0.1 mm. The thickness of the linking units 12 (T_bre) is can be less than 0.8T and greater than 0.1T, for example, less than 0.5T and greater than 0.1T. If the thickness of the linking units 12 (T_bre) is too thin, the manufacturing of the motherboard 10 may be difficult due to the difficulty to form the linking units 12 through the hot pressing or injection methods. Conversely, if the thickness of the linking units 12 (T_bre) is too thick, the disconnection of the light guide unit plates 11 may be difficult.

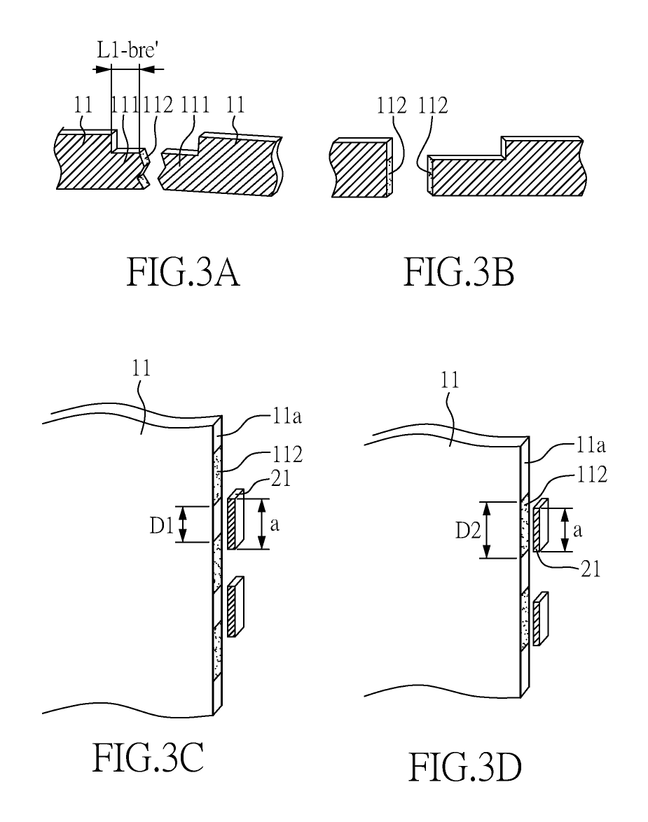

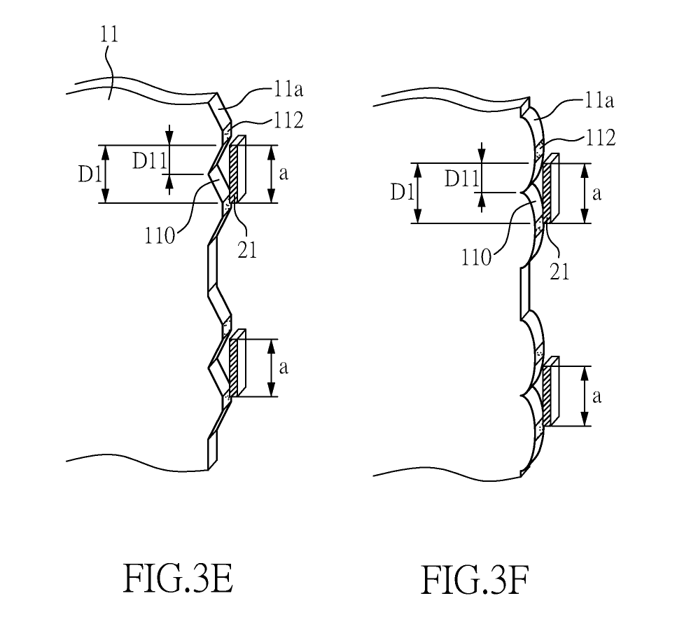

After breaking along the linking units 12, the light guide units 11 are disconnected. Each individual light guide unit 11 may be used as a light guide plate. The surface at disconnection has an irregular uneven surface with surface textures arranged in a direction substantially parallel to the direction of disconnection. At least one protrusion 111 having at least one rough region 112 may be formed on a lateral side of the light guide plate (FIG. 3A). Alternatively, at least one rough region 112 may form on a lateral side of the light guide plate without forming a protrusion (FIG. 3B). The position of the protrusion 111 having rough region 112 or the rough region 112 can be on the light-incident surface 11a of the light guide unit 11 (please refer to FIGS. 1B, 1C, 3A, and 3B). A roughness of the rough region 112 can be in a range from 0.18 μm to 0.7 mm. As FIG. 3A to 3C show, after the linking units 12 are broken, a length protruding from the light-incident surface 11a of the light guide unit 11 toward the light-emitting unit (that is, the light source 21) is defined as a length of the protrusion 111 (L1_bre′). If the length of the protrusion 111 (L1_bre′) is too long, the diffusion of the incident light may be affected. Accordingly, the length of the protrusion 111 (L1_bre′) can be in a range from 0 mm to 1 mm. In the case as shown by FIG. 3B, L1_bre′ is 0 mm.

In the present embodiment, the light-emitting unit comprises a plurality of light sources 21, as shown in FIGS. 3C and 3D. In order to increase the efficiency of light entry into the light guide plate, the light sources 21 and the rough regions 112 of the light guide plate (i.e., the light guide unit plate 11) may be disposed as FIGS. 3C and 3D showed. In FIG. 3C, at least one light source 21 is disposed adjacent and corresponding to a space between at least two adjacent rough regions 112. The light source 21 overlaps with parts of the two adjacent rough regions 112 simultaneously. When a length of the light source 21 along a lengthwise direction of the light-incident surface 11a is defined as “a” and a length of the space between the two adjacent rough regions 112 along the lengthwise direction of the light-incident surface 11a is defined as “D1”, “a” and “D1” satisfy a relationship of a>D1 and D1 may be greater than 0.01a. In FIG. 3D, at least one of the rough regions 112 is disposed corresponding to a light source 21. The light source 21 can completely overlap with the rough region 112. When a length of the light source 21 along a lengthwise direction of the light-incident surface 11a is defined as “a” and a length of the rough region 112 along the lengthwise direction of the light-incident surface 11a is defined as “D2”, “a” and “D2” satisfy a relationship of D2≧a. When the light-emitting unit (i.e., light source 21) and the rough region 112 satisfy the relationships defined above, the light emitted by the light source 21 toward the rough region 112 will be diffused by the rough region 112. Consequently, the amount of incident light entering into the light guide plate will increase, the luminance will increase, and the light guiding effect of the light guide plate will be enhanced.

In another embodiment of the present invention, the relationship between the light source 21 and the rough region 112 is shown in FIG. 3E. In this embodiment, the structure of the light guide plate is different from that of FIG. 3C. A concave structure 110 is formed between at least two adjacent rough regions 112. The concave structure 110 corresponds to a light source 21. Similar to the light guide plate shown in FIG. 3C, the light source 21 overlaps with parts of the two adjacent rough regions 112 simultaneously. When a length of the light source 21 along a lengthwise direction of the light-incident surface 11a is defined as “a”; a length of the space between the two adjacent rough regions 112 along the lengthwise direction of the light-incident surface 11a is defined as “D1”; a length between the edge of the rough region 112 closest to the concave structure 110 and the lowest point of the concave structure 110 along the lengthwise direction of the light-incident surface 11a is defined as “D11”, and “a”, “D1”, and “D11” satisfy a relationship of D1>D11>0.01a. D11 can be in the range from 0.4D1 to 0.6D1, and for example 0.5D1. The concave structure 110 is not limited to the V-shape concave structure as shown in FIG. 3E. Instead, the concave structure 110 may be designed to be a slightly-curved shape as shown in FIG. 3F. Nevertheless, the present invention is not limited thereto. Due to the configuration of the light sources 21 and the rough regions 112 shown in FIGS. 3E and 3F, the concave structures create larger light-emitting angles, thereby reducing hot spots while further improving light entry efficiency.

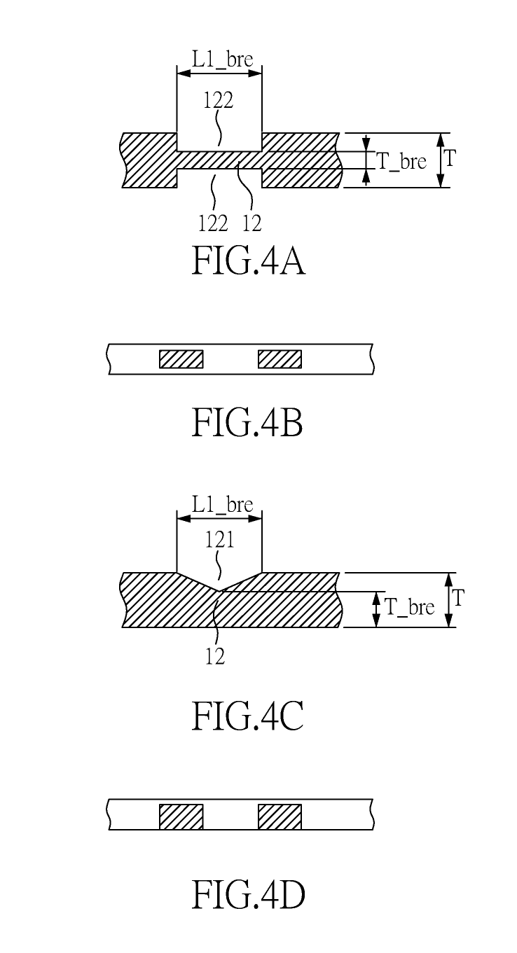

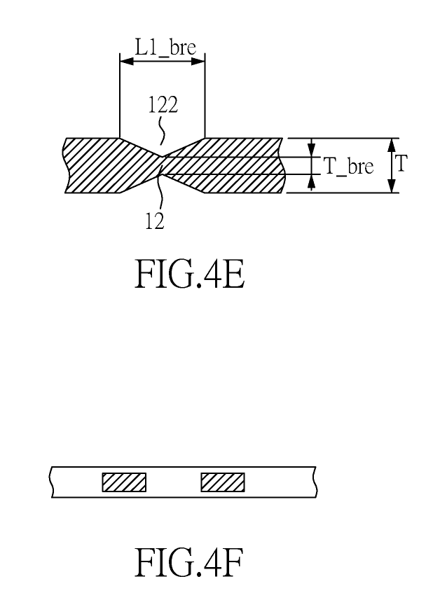

FIGS. 2B and 2C show the case when the linking unit 12 is recessed on one side to form a groove section 121 on a single side. However, the present invention is not limited thereto. As FIGS. 4A and 4B show (which are a cross-sectional views taken along line A-A and line B-B in FIG. 2A, respectively), the linking unit 12 may be recessed on two opposite sides to form groove sections 122 on both sides.

FIGS. 4C and 4D (which are a cross-sections taken along line A-A and line B-B in FIG. 2A, respectively) show another embodiment of a structure of the linking unit 12 in which the linking unit 12 is recessed to form a V-shape groove section 121 on a single side. In other words, in this embodiment, the linking unit 12 has a tapered design as shown by the A-A or B-B cross-sections of the linking unit 12. Similarly, the linking unit 12 may be recessed to form V-shaped groove sections 122 on both sides as shown in FIGS. 4E and 4F (which are a cross-section of A-A and a cross-section of B-B in FIG. 2A, respectively). Even the linking unit 12 can be designed in various structures mentioned above, some descriptions of the linking unit 12 mentioned above also apply. When L1 represents a width of a light guide unit plate 11; L2 represents a length of a light guide unit plate 11; L1_bre represents a length of a linking unit 12; L2_bre represents a width of a linking unit 12; T represents a thickness of a motherboard; and T_bre represents a thickness of a linking unit 12, the relationships of L1, L2, L1_bre, L2_bre, T, and T_bre are the same as previously described for the linking unit 12 of FIGS. 2B and 2C.

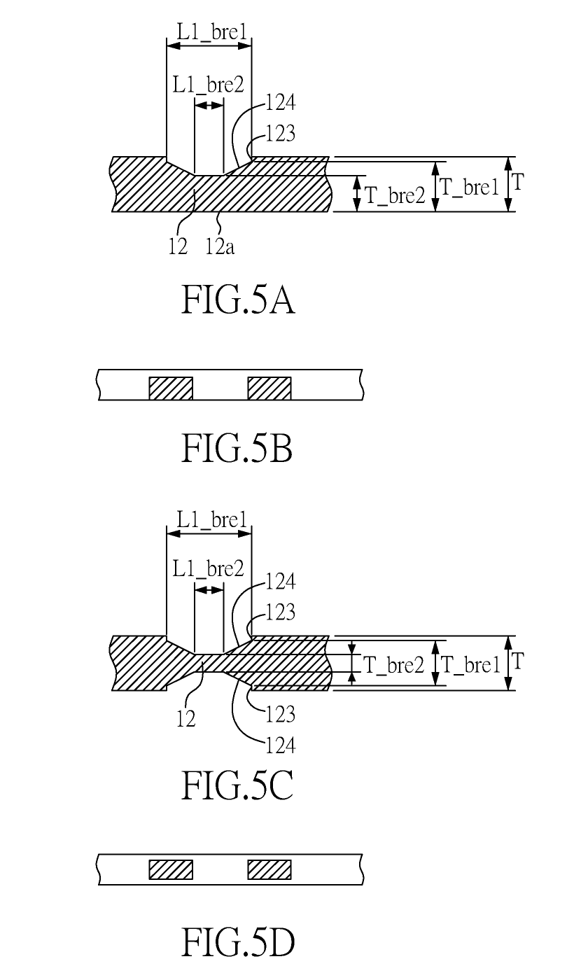

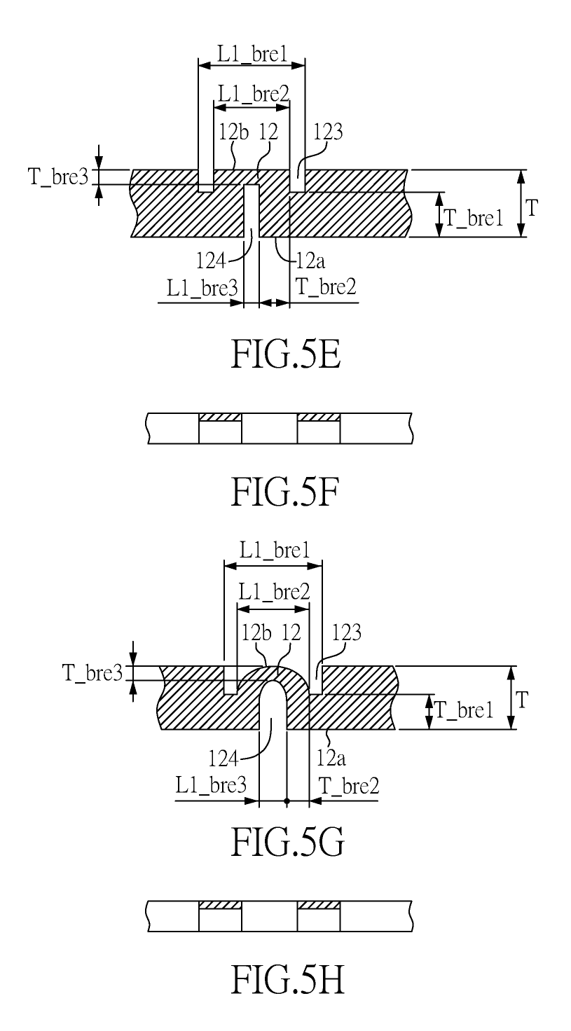

FIGS. 5A and 5B (which are a cross-section of A-A and a cross-section of B-B in FIG. 2A, respectively) show another embodiment of a structure of the linking unit 12. In FIG. 5A, the linking unit 12 is recessed to form a groove section on a single side. The groove section includes a first concave groove section 123 and a second groove section 124 below the first groove section 123. A thickness of the motherboard is defined as “T”; a thickness from a bottom surface 12a of the linking unit 12 to a bottom end of a first groove section 123 is defined as T_bre1; and a thickness from the bottom surface 12a of the linking unit 12 to a bottom surface of a second groove section 124 is defined as T_bre2, a width of the first groove section 123 is defined as L1_bre1, and a width of the second groove section 124 is defined as L1_bre2, where the relationships of L2>L2_bre, L1>L1_bre1>L1_bre2, and T>T_bre1>T_bre2 are satisfied.

FIGS. 5C and 5D (which are a cross-section of A-A and a cross-section of B-B in FIG. 2A, respectively) show another embodiment of a structure of the linking unit 12. The linking unit 12 is recessed to form two groove sections on two opposite sides. Each groove section includes a first concave groove section 123 and a second groove section 124 below the first groove section 123. Similar to FIGS. 5A and 5B, a thickness of the motherboard is defined as “T”; a thickness between the bottom ends of two opposite first groove sections 123 is defined as T_bre1; and a thickness between the bottom ends of two opposite second groove sections 124 is defined as T_bre2, a width of the first groove section 123 is defined as L1_bre1, and a width of the second groove section 124 is defined as L1_bre2, where the relationships of L2>L2_bre, L1>L1_bre1>L1_bre2, and T>T_bre1>T_bre2 are satisfied. As FIG. 5A to 5D show, the linking unit 12 has a tapered design as shown by the A-A or B-B cross-sections of the linking unit 12.

FIG. 5E to 5H show two embodiments of a structure of the linking unit 12 where FIGS. 5E and 5G are cross-sections of A-A in FIG. 2A while FIGS. 5F and 5H are cross-sections of B-B in FIG. 2A. The difference between FIGS. 5E and 5G is that the groove sections formed are in different shapes. Referring to FIGS. 5E and FIG. 5G, the linking unit 12 is recessed to form groove sections on two opposite sides. A first groove section 123 is formed on a first side, and a second groove section 124 is formed on a second side opposite to the first side. The first groove section 123 and the second groove section 124 can be not aligned along the width direction of the linking unit 12. A thickness of the light guide plate is defined as “T”; a thickness between the bottom 12a of the linking unit 12 to the bottom of the first groove section 123 is defined as “T_bre1”; a thickness between the first groove section 123 and the second groove section 124 is defined as “T_bre2”; a thickness between the bottom of the second groove section 124 to the top 12b of the linking unit 12 is defined as “T_bre3”; a maximum width between sidewalls of two adjacent first groove sections 123 is defined as “L1_bre1” while the minimum width is defined as “L1_bre2”; and the width of the second groove section 124 is defined as “L1_bre3”, where the relationships of L2>L2_bre, L1>L1_bre1>L1_bre2>L1_bre3, and T>T_bre1>T_bre2>T_bre3 are satisfied.

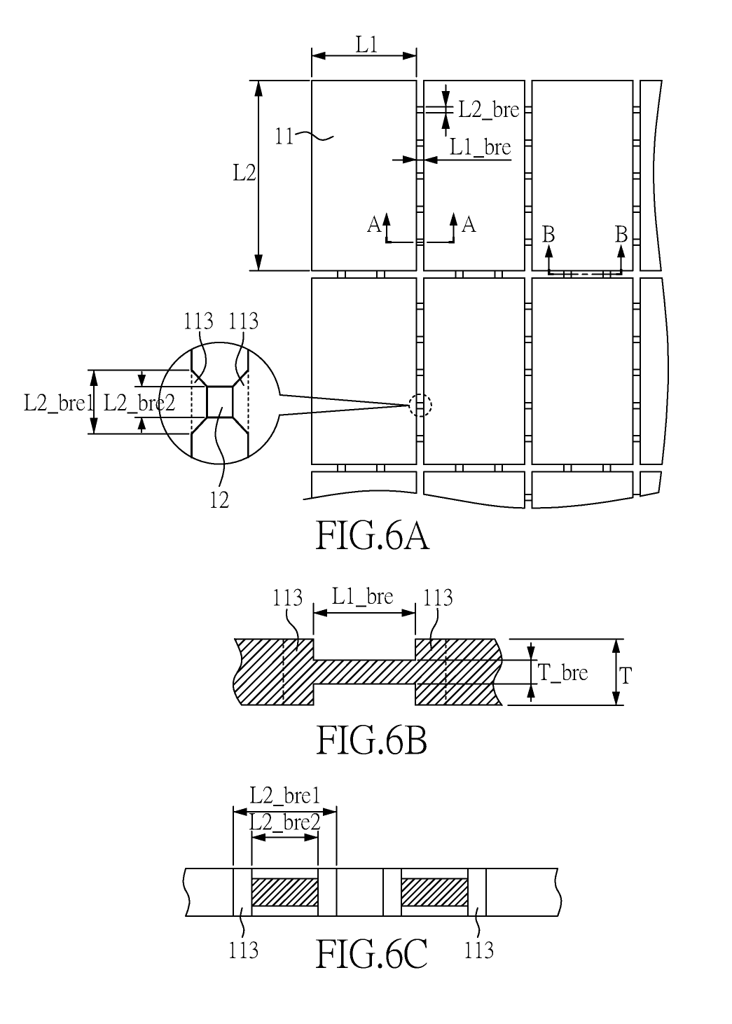

FIG. 6A to 6C show another embodiment of a structure of the linking unit 12, where FIGS. 6B and 6C are a cross-section of A-A and a cross-section of B-B in FIG. 6A, respectively. FIG. 6A shows a motherboard comprising a plurality of light guide units 11. On a side of the light guide unit 11 with a linking unit 12 disposed, at least one trapezoid-shaped protrusion 113 is disposed on this side and between the light guide unit 11 and the linking unit 12. The shorter edge of the trapezoid-shaped protrusion 113 is connected to the linking unit 12. For example, at least one trapezoid-shaped protrusion 113 is disposed on each of two opposite sides of the light guide unit 11. As shown by the enlarged view of FIG. 6A, two adjacent trapezoid-shaped protrusions 113 disposed on two adjacent light guide units 11 are connected to the linking unit 12 along the shorter edges of the trapezoid-shaped protrusions 113. Here, “L1” represents a width of a single light guide unit plate 11; “L2” represents a length of a single light guide unit plate 11; “L2_bre1” represents a width of the longer edge of the trapezoid-shaped protrusion 113; “L2_bre2” represents a width of the shorter edge of the trapezoid-shaped protrusion 113; and “L2_bre” represents a width of the linking unit 12 (in the present embodiment, the width of the linking unit 12 equals to the width of the shorter edge of the trapezoid-shaped protrusion 113, that is, L2_bre=L2_bre2), where the relationships of T>T_bre, L1>L1_bre, and L2>L2_bre1>L2_bre2 are satisfied.

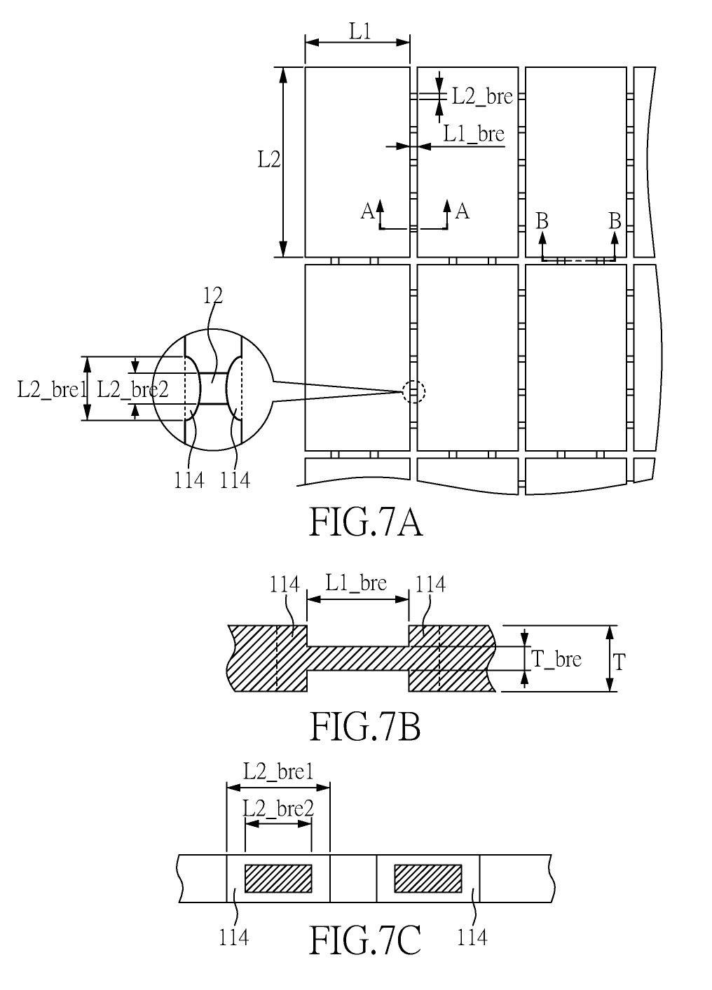

FIG. 7A to 7C show another embodiment of a structure of the linking unit 12, where FIGS. 7B and 7C are a cross-section of A-A and a cross-section of B-B in FIG. 7A, respectively. FIG. 7A shows a motherboard comprising a plurality of light guide units 11. On a side of the light guide unit 11 with a linking unit 12 disposed, at least one arc-shaped protrusion 114 is disposed on this side and between the light guide unit 11 and the linking unit 12. The arc edge of the arc-shaped protrusion 114 is connected to the linking unit 12. For example, at least one arc-shaped protrusion 114 is disposed on each of two opposite sides of the light guide unit 11. As shown by the enlarged view of FIG. 7A, two adjacent arc-shaped protrusion 114 disposed on two adjacent light guide units 11 are connected to the linking unit 12 along the arc edges of the arc-shaped protrusions 114. Here, “L1” represents a width of a single light guide unit plate 11; “L2” represents a length of a single light guide unit plate 11; “L2_bre1” represents a width of the longer edge of the arc-shaped protrusion 114; “L2_bre2” represents a width of the arc edge of the arc-shaped protrusion 114 connected to the linking unit 12; and “L2_bre” represents a width of the linking unit 12 (in the present embodiment, the width of the linking unit 12 equals to the width of the arc edge of the arc-shaped protrusion 114 connected to the linking unit 12, that is L2_bre=L2_bre2), where the relationships of T>T_bre, L1>L1_bre, and L2>L2_bre1>L2_bre2 are satisfied.

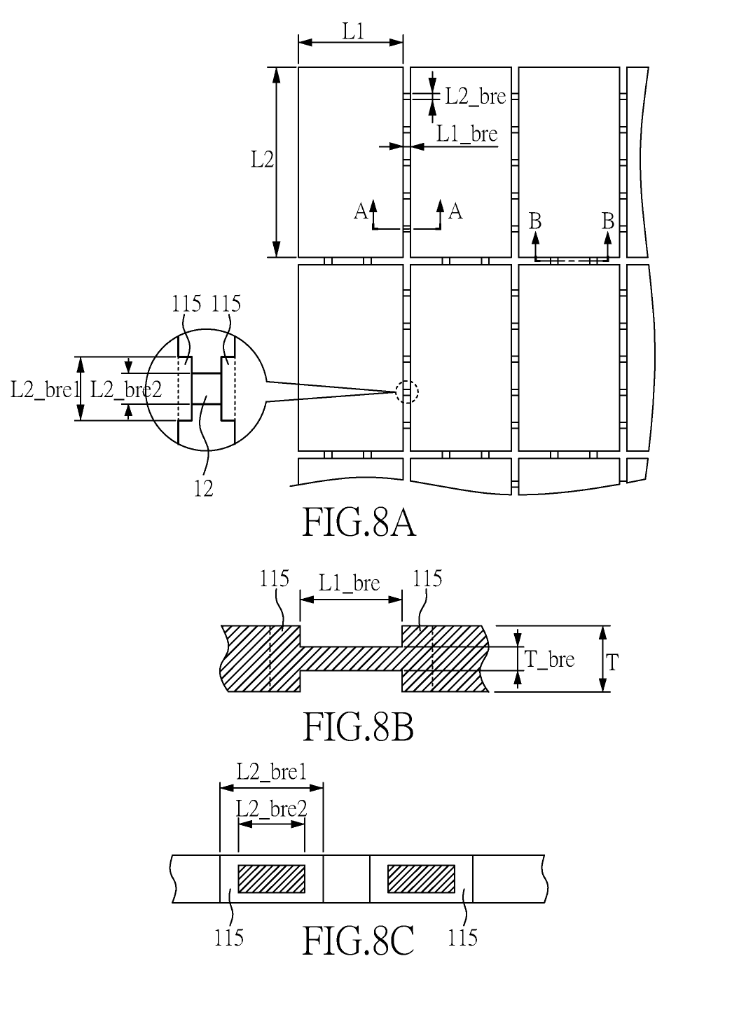

FIG. 8A to 8C show another embodiment of a structure of the linking unit 12, where FIGS. 8B and 8C are a cross-section of A-A and a cross-section of B-B in FIG. 8A, respectively. FIG. 8A shows a motherboard comprising a plurality of light guide units 11. On a side of the light guide unit 11 with a linking unit 12 disposed, at least one rectangular-shaped protrusion 115 is disposed on this side and between the light guide unit 11 and the linking unit 12. For example, at least one rectangular-shaped protrusion 115 is disposed on each of two opposite sides of the light guide unit 11. As shown by the enlarged view of FIG. 8A, two rectangular-shaped protrusion 115 disposed on two adjacent light guide units 11 are connected to the linking unit 12. Here, “L1” represents a width of a single light guide unit plate 11; “L2” represents a length of a single light guide unit 11; “L2_bre1” represents a width of the rectangular-shaped protrusion 115; “L2_bre2” represents a width of the edge of the rectangular-shaped protrusion 115 connected to the linking unit 12; and “L2_bre” represents a width of the linking unit 12 (in the present embodiment, the width of the linking unit 12 equals to the width of the edge of the rectangular-shaped protrusion 115 connected to the linking unit 12, that is L2_bre=L2_bre2), where the relationships of T>T_bre, L1>L1_bre, and L2>L2_bre1>L2_bre2 are satisfied.

According to some embodiments of the present invention, the shape of the protrusions on the side of the light guide unit 11 with the linking unit 12 disposed are not limited to the trapezoid-shaped protrusions 113 of FIG. 6A to 6C, the arc-shaped protrusions 114 of FIG. 7A to 7C, or the rectangular-shaped protrusions 115 of FIG. 8A to 8C. The protrusions may have other shape, for example, pentagonal shape, hexagonal shape, or other special shapes.

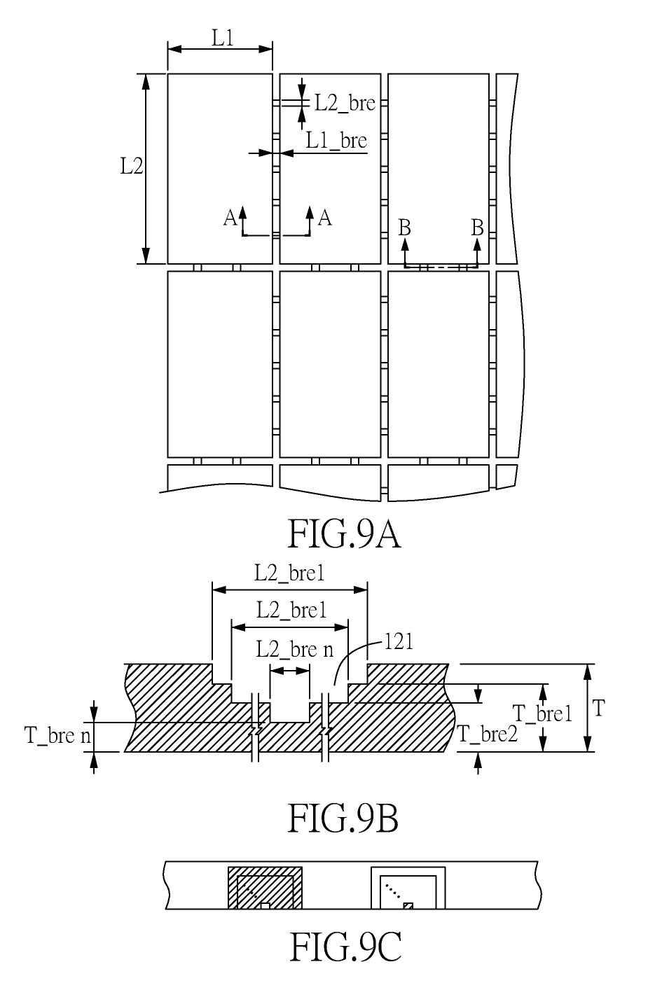

In addition to the linking unit recessed on a single side to form a groove section as shown in FIG. 2B, the linking unit 12 can also be recessed on a single side by more than one time, for example, by multiple times to form a groove section with more than one groove portion or with multiple groove portions, as shown in FIG. 9A to 9C (where FIGS. 9B and 9C are a cross-section of A-A and a cross-section of B-B in FIG. 9A, respectively). Similarly, the linking unit can also be recessed on two opposite sides to form two groove sections on both sides. Each groove section can also include more than one groove portion or multiple groove portions. When the groove section 121 is formed by n times of recessions (where n is an integer greater than 1), no matter on one side or on both sides, the relationships of T>T_bre1>T_bre2> . . . T_bre n and L2>L2_bre1>L2_bre2> . . . L2_bre n are satisfied.

In the embodiments described above, when disconnection is performed to obtain individual light guide units, the disconnected positions are located on the linking units. Moreover, the disconnected positions can be the thinnest portions of the linking units of the motherboard.

When using the light guide plates shown in FIG. 4A to 9C to display device application, the structural relationship between the light sources and the rough regions after disconnecting adjacent light guide unit plates are the same as described in FIG. 3C to 3F. Accordingly, they will not be described here again.

### EXAMPLE 3

### Bendable Light Guide Plate

According to some embodiments, another type of light guide plate can also be used in a display device. The light guide plate 1 is not a single light guide unit as described in the previous embodiment, but can include a plurality of light guide units 11. Adjacent light guide units 11 can be linked together by at least one linking unit 12, for example, by more than one linking units 12. The length and width of the linking units 12 are the same as EXAMPLE 2, and thus, will not be discussed here.

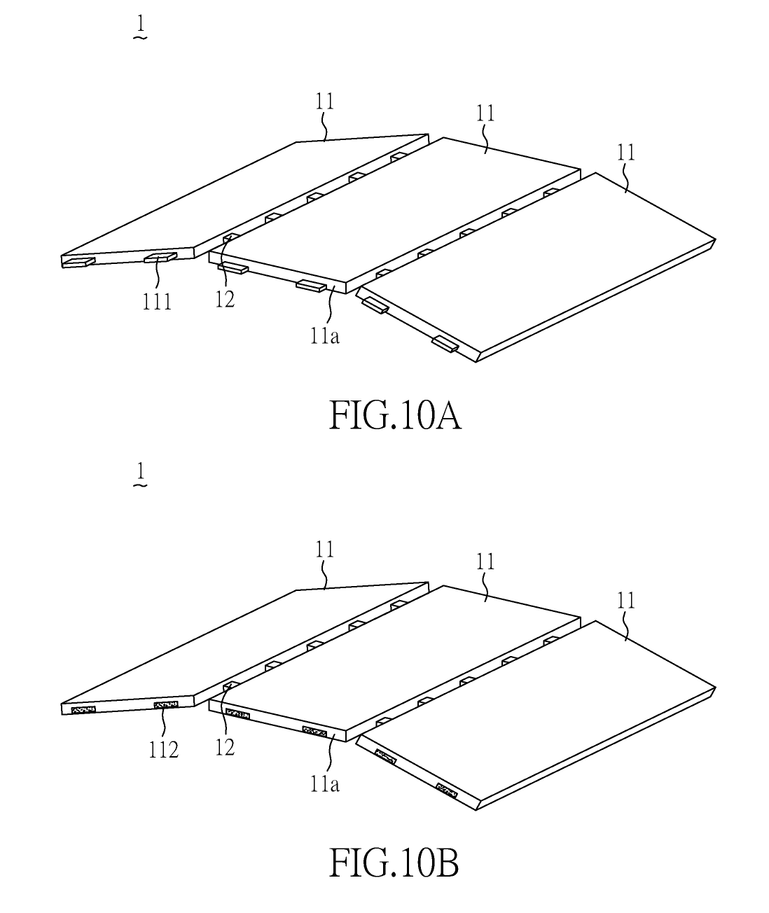

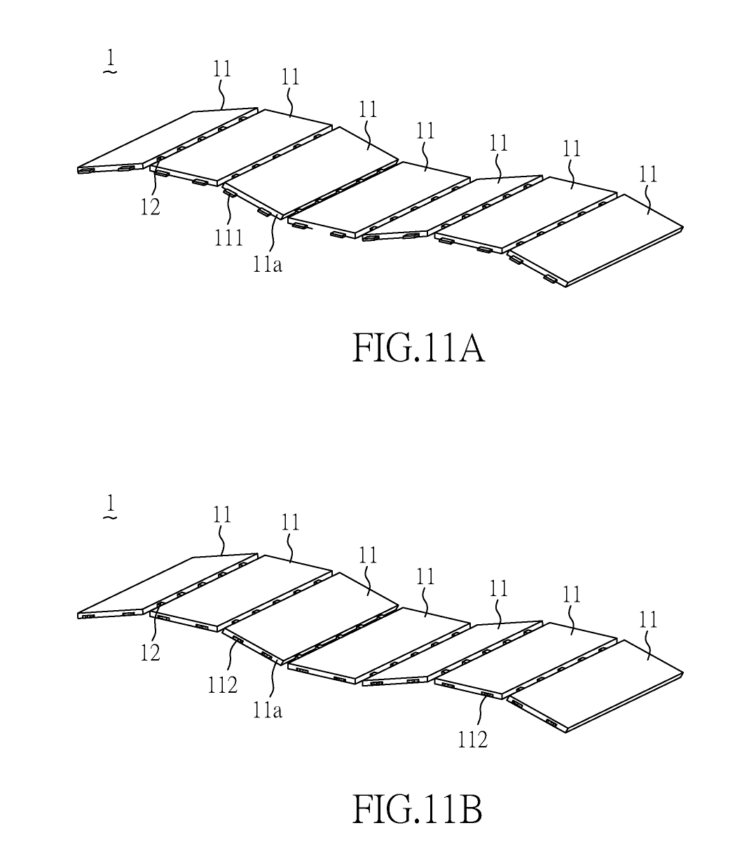

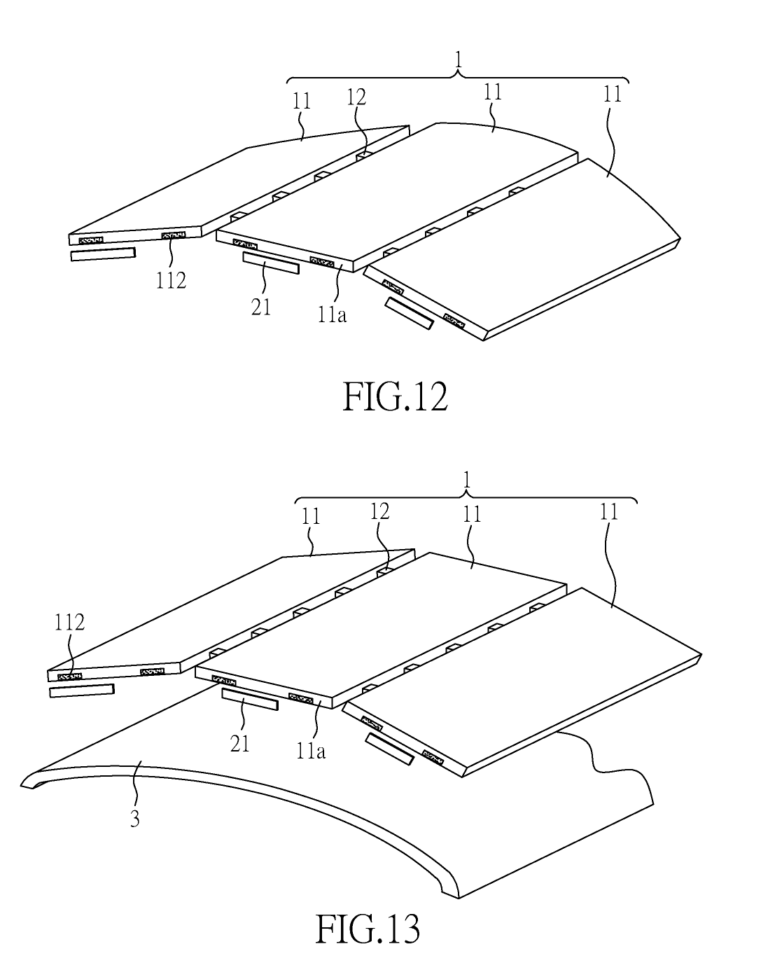

When bending the linking units 12 without breaking them, the obtained light guide plate 1, including a plurality of light guide units, will become a bendable light guide plate, as shown in FIGS. 10A and 10B, which can be used in a curved display In FIG. 10A, at least one protrusion 111 having rough region is formed on the light-incident surface 11a. In FIG. 10B, at least one rough region 112 is formed on the light-incident surface 11a without any protrusion. The number of the light guide units constituting the light guide plate is not particularly limited and may be adjusted based on the curved display to be applied. For example, as shown in FIGS. 11A and 11B, when the light guide plate is to be applied to a curved TV screen, the light guide plate may comprise several light guide units 11 linked to each other by the linking units 12 and bent into an arc-shape by bending the linking units 12. In FIG. 11A, a least one protrusion 111 having a rough region is formed on the light-incident surface 11a of the light guide plate. In FIG. 11B, at least one rough region 112 is formed on the light-incident surface 11a of the light guide plate without any protrusion. In another embodiment as shown by FIG. 12, when the light guide plate is to be applied to an automobile display screen, the shape of the light guide units 11 are appropriately adjusted to match the beautiful arc shaped appearance of the display panel. For example, to match the appearance of the display panel, the light guide units 11 may have outer contours with asymmetrical shapes. In the present embodiment, each of the light guide unit 11 has a curved side. The curved sides are connected to form a smooth large arc side. Nonetheless, the present invention is not limited thereto.

In some embodiments of the present invention, the protrusions 111 obtained after bending and breaking the linking units 12 (in some situations, there would only be rough regions without any protrusions) have the same structure and function as described in EXAMPLE 2, and thus, will not be discussed here. Furthermore, in other embodiments of the present invention, the protrusions 111 obtained after bending and breaking the linking units 12 may be removed or partially removed by the polishing method described and shown in FIGS. 1B and 1C.

In the present embodiment, the locations where the light-emitting units are disposed are the same as EXAMPLE 2. The side of the light guide plate with protrusions 111 is the light-incident surface 11a. The light-emitting units (i.e. at least one light source 21) are disposed adjacent to the light-incident surface 11a. The relative relationships between the light sources and the rough regions after disconnecting adjacent light guide units are also the same as described in EXAMPLE 2. Accordingly, they will not be discussed further.

The light guide plate manufactured according to the embodiments of the present invention as described above may be used in a display device by conventional methods and means. For example, as shown in FIG. 13, the display device includes a curved display panel 3, a light guide plate 1, and a plurality of light sources 21. The light guide plate 1 is disposed on a side of the display panel 3 and has a light-incident surface 11a. The light guide plate includes a plurality of light guide units 11 connected to each other by the linking units 12 and bent into an arc. The plurality of light sources 21 are disposed adjacent to the light-incident surface 11a of the light guide plate 1. The display panel 3 may be a LCD or OLED display panel having a curved surface or a flexible LCD or OLED display panel. The display panel 3 may also have a touch control function or may be built with a touch panel. In addition, at least one optical layer, such as a diffusion plate or a brightness enhancement film, may be disposed between the display panel 3 and the light guide plate 1. Nevertheless, the display device is only one of the embodiments of the present invention, which is provided for explanation and as an example. It is to be understood that many other possible modifications and variations can be made without departing from the spirit and scope of the invention as hereinafter claimed.

What is claimed is:

1. A display device, comprising:
a display panel;
a light guide plate disposed on a side of the display panel and having a light-incident surface and a thickness; and
a light-emitting unit disposed adjacent to the light-incident surface of the light guide plate;
wherein at least one rough region is formed on the light-incident surface, and a surface of the rough region has roughness in a range from 0.18 μm to 0.7 mm.

2. The display device as claimed in claim 1, wherein the light guide plate has at least one protrusion, the rough region is formed on the protrusion, and the protrusion has a thickness thinner than that of the light guide plate.

3. The display device as claimed in claim 1, wherein the light-emitting unit comprises plural light sources, and at least one of the light sources is disposed adjacent and corresponding to a space between at least two adjacent rough regions, and when a length of the light source along a lengthwise direction of the light-incident surface is defined as “a” and a length of the space between any two adjacent rough regions along the lengthwise direction of the light-incident surface is defined as “D1”, “a” and “D1” satisfy a relationship of a>D1.

4. The display device as claimed in claim 1, wherein the light-emitting unit comprises plural light sources, and at least one of the rough regions is disposed corresponding to at least one of the light source, and when a length of the light source along a lengthwise direction of the light-incident surface is defined as “a” and a length of the rough region along the lengthwise direction of the light-incident surface is defined as “D2”, “a” and “D2” satisfy a relationship of D2≧a.

5. The display device as claimed in claim 1, wherein the light-emitting unit comprises plural light sources, and a concave structure is disposed between at least two adjacent rough regions, and the concave structure is disposed corresponding to at least one of the light sources.

6. A display device, comprising:
a display panel;
a light guide plate disposed on a side of the display panel and having a light-incident surface and a thickness, the light guide plate comprising a plurality of light guide units; and
a light-emitting unit disposed adjacent to the light-incident surface of the light guide plate;
wherein at least two adjacent light guide units are linked by at least one linking unit.

7. The display device as claimed in claim 6, wherein at least one rough region is formed on the light-incident surface of the light guide plate, and a surface of the rough region has roughness in a range from 0.18 μm to 0.7 mm.

8. The display device as claimed in claim 7, wherein the light guide plate has at least one protrusion, the rough region is formed on the protrusion, and the thickness of the protrusion is thinner than that of the light guide plate.

9. The display device as claimed in claim 6, wherein the display panel is a liquid crystal display panel or an organic light emitting diode display panel, the display panel has a curved surface, and the light guide plate is disposed corresponding to the display panel by bending the linking units.

10. The display device as claimed in claim 6, wherein at least one of the light guide units has an outer contour with asymmetrical shape.
